(19) United States
(12) Patent Application Publication
(10) Pub. No.: US 2026/0126848 A1
(43) Pub. Date: May 7, 2026

(54) Power and Thermal Management for Multiple Processing Cores

(71) Applicant: Google LLC, Mountain View, CA (US)

(72) Inventors: Guibing Cai, Sunnyvale, CA (US); Wei Wang, Palo Alto, CA (US); Sayanna Chandula, San Jose, CA (US)

(73) Assignee: Google LLC, Mountain View, CA (US)

(21) Appl. No.: 19/425,389

(22) Filed: Dec. 18, 2025

Related U.S. Application Data
(60) Provisional application No. 63/942,788, filed on Dec. 17, 2025.

(51) Int. Cl. G06F 1/3296; G06F 1/20; G06F 1/3234; G06F 1/324; G06F 1/329

(52) U.S. Cl. CPC G06F 1/3296; G06F 1/206; G06F 1/324; G06F 1/3243; G06F 1/329

(57) ABSTRACT

A method and apparatus for power and thermal management for multiple processing cores are disclosed. Existing dynamic voltage and frequency scaling (DVFS) approaches typically perform localized management for individual cores, such as a central processing unit (CPU) or a graphics processing unit (GPU), resulting in suboptimal overall power consumption and thermal throttling. The disclosed energy manager addresses this by performing energy management across at least two computing cores executing a hybrid workload with a shared execution deadline. The energy manager acquires historical performance data to predict the execution time and total power consumption for a plurality of voltage and frequency combinations. An optimal combination is selected that minimizes the total predicted power consumption while meeting the deadline. The system further determines a thermal constraint, such as a thermal power budget, and restricts the available voltage and frequency combinations, ensuring continuous operation within safe thermal limits while improving power efficiency.

### CROSS-REFERENCE TO RELATED APPLICATION

This application claims the benefit of U.S. Provisional Patent Application Ser. No. 63/942,788 filed on Dec. 17, 2025, the disclosure of which is incorporated by reference herein in its entirety.

### SUMMARY

A method and apparatus for power and thermal management for multiple processing cores are disclosed. Existing dynamic voltage and frequency scaling (DVFS) approaches typically perform localized energy management for individual cores, such as a central processing unit (CPU) or a graphics processing unit (GPU), resulting in suboptimal overall power consumption and thermal throttling. The disclosed energy manager addresses this by performing coordinated voltage and frequency management across at least two computing cores executing a hybrid workload with a shared execution deadline. The energy manager acquires historical performance data to predict the execution time and total power consumption for a plurality of voltage and frequency combinations. An optimal combination is selected that minimizes the total predicted power consumption while meeting the deadline. The system further determines a thermal constraint, such as a thermal power budget, and restricts the available voltage and frequency combinations, ensuring continuous operation within safe thermal limits while improving power efficiency.

This document describes techniques and apparatuses, implemented on computing devices (e.g., mobile phones, tablets, and gaming consoles), for power and thermal management for multiple processing cores. In modern computing devices, particularly mobile platforms with multiple processing cores, tasks are often split across different types of cores, such as a CPU and a GPU. These hybrid workloads, like rendering a user interface (UI) frame, share a common performance deadline. Conventional power management systems often manage each core independently using dynamic voltage and frequency scaling (DVFS). This can lead to suboptimal power consumption for the system as a whole, as the coordination needed to meet the shared deadline most efficiently is lacking. For instance, one core might operate at a higher, less efficient frequency than necessary, increasing overall power draw and device temperature. This can trigger thermal throttling, which may degrade the user experience by causing missed deadlines and reduced frame rates. This system is designed to provide power efficiency and performance by coordinating the operation of heterogeneous computing cores (e.g., a CPU and a GPU) and integrating the resulting control decisions with thermal limits.

In aspects, the present disclosure relates to a method for power and thermal management for multiple processing cores. The method includes receiving a hybrid workload with an execution deadline. The method further includes identifying, based on timeline data and power consumption data, a plurality of voltage and frequency combinations for a first computing core and a second computing core by which to complete the hybrid workload within the execution deadline. The method also includes adjusting, based on a selected one of the voltage and frequency combinations, an operating voltage and frequency of the first computing core and the second computing core, the adjustment effective to cause the first computing core and the second computing core to complete the hybrid workload within the execution deadline.

In aspects, the present disclosure relates to a thermal-aware method. The method includes receiving a hybrid workload with an execution deadline. The method includes determining a thermal constraint for the hybrid workload based on at least one of temperature data and a thermal power budget. The method includes identifying, based on timeline data and power consumption data, a plurality of voltage and frequency combinations for a first computing core and a second computing core by which to complete the hybrid workload within the execution deadline, where the plurality of voltage and frequency combinations is constrained by the thermal constraint. The method includes adjusting, based on a selected one of the voltage and frequency combinations, an operating voltage and frequency of the first computing core and the second computing core based on a selected one of the voltage and frequency combinations.

This document also describes aspects that may include one or more of the following features. In aspects, the first computing core may be a CPU, and the second computing core may be a GPU. In aspects, the timeline data may include an overlap period during simultaneous core execution. In further aspects, the timeline data and power consumption data may further include data associated with a third computing core, the third computing core comprising a tensor processing unit (TPU) or a neural processing unit (NPU). In aspects, the identifying may include determining a predicted total completion time using the first computing core and the second computing core and comparing the predicted total completion time to the execution deadline. In other aspects, the identifying may include estimating a power cost difference for the CPU that is calculated based on: a latest measured power of a core cluster associated with the CPU; a change in a power efficiency due to the adjusting the operating voltage and frequency to the selected one of voltage and frequency combinations; and a ratio of total processing cycles for active hybrid workload tasks relative to total processing cycles for a target duration of the core cluster. In further aspects, the method may include the power efficiency is estimated based on a previous operating efficiency of the CPU and a new operating efficiency of the CPU. In further aspects, identifying may further include estimating a total power consumption by summing the estimated power cost difference for the CPU and an estimated power cost difference for the GPU.

This document also describes computer-readable media having instructions for performing the above-summarized method and other methods set forth herein, as well as systems and means for performing these methods.

This Summary is provided to introduce simplified concepts for power and thermal management for multiple processing cores, which is further described below in the Detailed Description and is illustrated in the Drawings. This Summary is intended neither to identify essential features of the claimed subject matter nor for use in determining the scope of the claimed subject matter.

### BRIEF DESCRIPTION OF THE DRAWINGS

The details of one or more aspects of power and thermal management for multiple processing cores are described throughout the disclosure with reference to the Drawings. The use of the same reference numbers in different instances in the Detailed Description and the Drawings indicates same or similar elements:

FIG. 1 illustrates an example operating environment and apparatus in which aspects of power and thermal management for multiple processing cores may be implemented;

FIG. 2 illustrates an example execution environment for power and thermal management for multiple processing cores;

FIG. 3 illustrates an example processor core timeline for showing the thermal overlap period for power and thermal management for multiple processing cores; and

FIG. 4 illustrates an example method for power and thermal management for multiple processing cores.

FIG. 5 illustrates an example method for implementing thermal constraint and throttling for power and thermal management for multiple processing cores.

### DETAILED DESCRIPTION

This document describes techniques and apparatuses for power and thermal management for multiple processing cores. The modern computing environment, particularly mobile and embedded systems, relies on heterogeneous system-on-chip (SoC) architectures that integrate multiple types of processing units, such as CPUs and GPUs. These systems execute complex hybrid workloads that require the cooperation of these multiple cores, often under a strict performance deadline (e.g., maintaining a constant frame rate).

In some existing systems, power management for these cores relies on locally-scoped algorithms. For example, the power controller for the CPU may operate based only on CPU utilization, and the GPU controller may operate based only on its own workload patterns. Without a coordinating mechanism, individual processors may make operating decisions that are not efficient for the total power consumption of the combined system. Consequently, one core may operate at a higher voltage and frequency combination than needed for the shared task, which can increase its local speed but potentially cause another core to throttle or operate inefficiently, leading to suboptimal total power consumption for the device.

Such power decisions can have negative operational effects. The increased power draw may cause the device's temperature to rise, which can trigger the thermal management system. Some thermal throttling mechanisms apply voltage and frequency adjustments based primarily on temperature, without also considering the specific deadlines of a hybrid workload. This response can cause processing delays that jeopardize the shared execution deadline, resulting in performance degradation, such as dropped frames or increased latency. The systems and methods described herein are directed to overcoming these effects by introducing a coordinated control system.

The disclosed techniques and apparatuses relate to methods for coordinated power and thermal management in a computing device having multiple, heterogeneous processing cores, including a CPU and a GPU. The system is designed to execute a hybrid workload, which is a single task split across the cores and subject to a single, shared execution deadline.

The process is managed by an EMM, which receives the shared hybrid workload and acquires coordination data. This data includes historical data about performance timelines and power consumption for each core, providing a basis for predicting future execution times. This historical data accounts for the execution characteristics of the workload, including the overlap period where a first computing core and the second computing core run in parallel.

Using this timeline and operational data, the EMM identifies potential operating states, represented as voltage and frequency combinations, which are predicted to complete the hybrid workload within the shared execution deadline. This results in a deadline-feasible pool of solutions. To increase efficiency, the system then performs an adjustment by selecting the specific voltage and frequency combination from this deadline-feasible pool that corresponds to a lower total predicted power consumption of both computing cores simultaneously.

In aspects, the method integrates thermal management into the adjustment process. The EMM determines a thermal constraint for the hybrid workload based on the device's thermal state or a designated thermal power budget. This thermal constraint acts as a dynamic cap, restricting the plurality of available voltage and frequency combinations before the selection process begins. By helping ensure all candidate solutions are thermally compliant, the system confirms that the final selected combination is not only the most power-efficient option that meets the performance deadline but also maintains continuous operation within safe thermal limits. The EMM then adjusts the operating voltage and frequency of the first computing core and the second computing core according to the chosen lowest-power, deadline-feasible, and thermally compliant combination.

### Example Environment

The following discussion describes an operating environment, techniques that may be employed in the operating environment, and various devices or systems in which components of the operating environment may be embodied. In the context of the present disclosure, reference is made to the operating environment by way of example only.

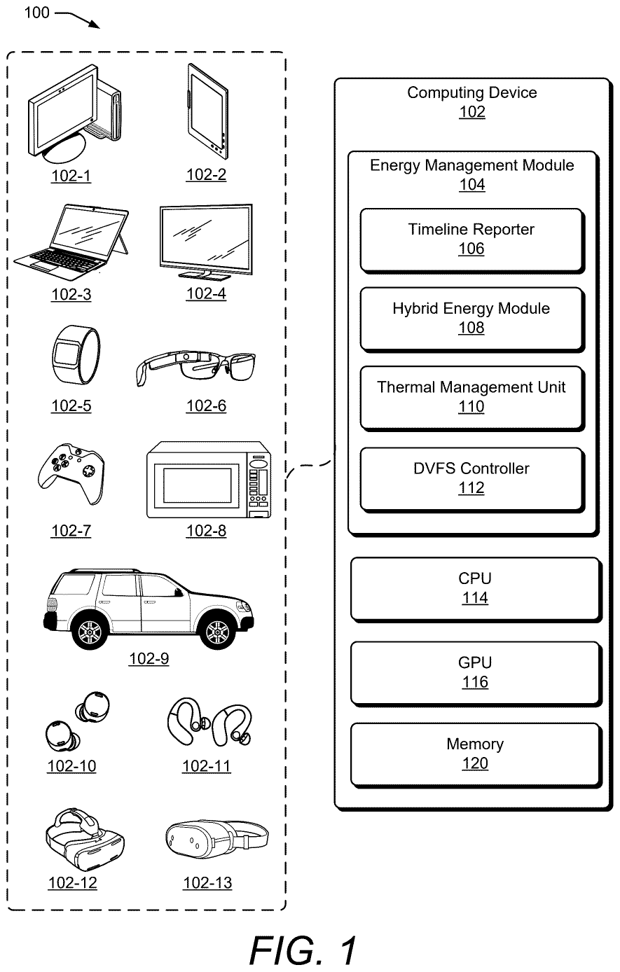

FIG. 1 illustrates an example operating environment 100 in which aspects of power and thermal management for multiple processing cores may be implemented with one or more aspects. In aspects, the environment in FIG. 1 includes a computing device 102, which represents any apparatus capable of executing a hybrid workload across multiple processing units. Examples of the computing device 102 include, but are not limited to, a desktop computer (102-1), a tablet device (102-2), a laptop computer (102-3), a large display or television (102-4), a smartwatch or wearable device (102-5), smart glasses or a head-mounted display (102-6), a gaming controller (102-7), an appliance such as a microwave oven (102-8), an automobile or vehicle (102-9), wireless earbuds or headphones (102-10), a wireless earpiece or hearing aid (102-11), a wearable bag or backpack (102-12), and a virtual reality (VR) headset (102-13).

The computing device 102 includes several hardware and functional blocks, including a CPU 114, a GPU 116, and memory 120. The CPU 114 represents a first computing core configured to execute general-purpose or sequential threads of the hybrid workload. The GPU 116 represents a second computing core, often configured for parallel processing, and executes tasks related to rendering or graphics processing associated with the hybrid workload. In various implementations, the CPU 114 and the GPU 116 may execute portions of the same hybrid workload simultaneously or sequentially, creating a shared execution deadline for the overall task completion. The memory 120 provides storage for the hybrid workload instructions, historical execution data, and the models utilized by the EMM 104.

The primary functional component described is the EMM 104. The EMM 104 represents the control logic or processor circuitry configured to perform the method steps, including predicting execution performance and regulating the power consumption settings of the CPU 114 and the GPU 116. The EMM 104 is coupled to the CPU 114, the GPU 116, and the memory 120.

The EMM 104 contains several functional sub-modules that enable its operations: the timeline reporter 106 represents the circuitry or logic configured to acquire data regarding past execution of hybrid workloads. The timeline reporter 106 receives historical averages of timelines from the CPU 114 and the GPU 116. This collected data includes information such as the total time spent by the CPU 114 on its portion of the workload, the total time spent by the GPU 116, and any period of overlap during which both cores were actively executing related portions of the hybrid workload. The EMM 104 uses this data to build a model of performance scaling.

The hybrid energy module 108 represents the predictive logic configured to model the performance and power changes resulting from adjusting the core processors'operating states. The hybrid energy module 108 utilizes the historical data received by the timeline reporter 106 to calculate estimated power consumption levels for a variety of candidate voltage and frequency combinations for the CPU 114 and the GPU 116. This module performs the calculations necessary to predict the total energy cost for the combined operation of the heterogeneous cores under different operating conditions.

The thermal management unit (TMU) 110 represents the logic configured to incorporate thermal awareness directly into the core management process. The TMU 110 receives temperature data from device sensors (not explicitly shown) and determines a thermal constraint for the hybrid workload. This constraint, which may be based on a fixed thermal power budget, sets a boundary on the power consumption permissible for the CPU 114 and the GPU 116. The TMU 110 uses this boundary to restrict the set of voltage and frequency combinations available for selection, so that the operation of the device stays within safe thermal limits.

The DVFS controller 112 represents the final control interface, configured to translate the EMM's selection into physical hardware signals. Once the EMM 104 selects a preferred voltage and frequency combination for the CPU 114 and the GPU 116, the DVFS controller 112 adjusts the operating voltage and frequency of the CPU 114 and the GPU 116 accordingly, implementing the coordinated power management decision.

The EMM 104 collectively uses its sub-modules to perform the method steps of receiving the hybrid workload, identifying numerous execution deadline feasible voltage and frequency combinations, restricting that plurality by the thermal constraint, selecting the lower power consumption combination from the remaining pool, and finally adjusting the cores via the DVFS controller 112.

### Example Devices and Systems

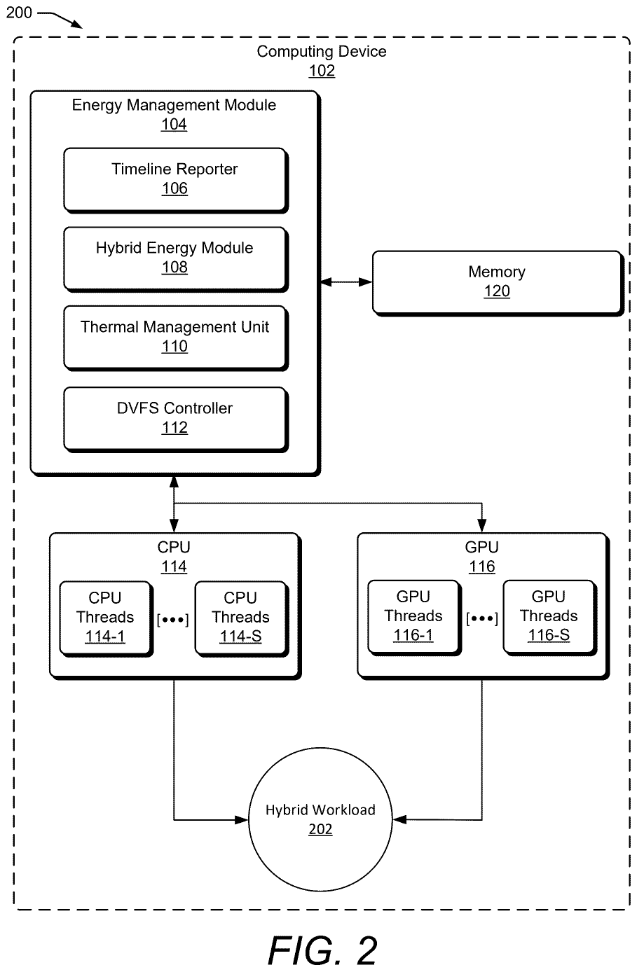

FIG. 2 illustrates an example execution environment 200 for power and thermal management for multiple processing cores. This figure details the functional flow and data dependencies between the control logic and the core processors during the processing of a shared workload.

The environment resides within the computing device 102 (first introduced in FIG. 1) and includes the EMM 104, the CPU 114, the GPU 116, and the memory 120. The shared task being executed is the hybrid workload 202. The hybrid workload 202 represents any task, such as a frame rendering pipeline (e.g., in gaming or UI interaction), that requires processing capacity from at least two different computing units. This hybrid workload 202 has a shared execution deadline by which the collective work of all cores must be completed.

The hybrid workload 202 is split into tasks or threads that are distributed to the CPU 114 and the GPU 116. The CPU 114 is shown executing CPU threads (114-1 through 114-S), where ‘S’ represents a plurality of threads. The GPU 116 is shown executing GPU threads (116-1 through 116-S). The arrows indicate that the hybrid workload 202 flows between the CPU 114 and the GPU 116. For example, the CPU 114 may execute an initial set of computational threads, and the resulting data is subsequently passed to the GPU 116 for execution of rendering threads. This cooperative execution describes the shared nature of the workload.

The EMM 104 is the central control logic for the execution environment 200. The EMM 104 is coupled to the CPU 114 and the GPU 116 and receives continuous data feedback from them while transmitting control signals (voltage and frequency adjustments) back to them.

For example, consider the hybrid workload 202 as a single frame rendering request in a mobile gaming application. The shared execution deadline for this frame may be 16.67 milliseconds (ms) to maintain a steady 60 frames per second (FPS). The CPU 114 executes threads 114-1 through 114-S responsible for game physics, object preparation, and command queue submission to the GPU 116. The GPU 116 then executes threads 116-1 through 116-S responsible for vertex shading and pixel rendering.

Within the EMM 104, the timeline reporter 106 receives historical averages of execution times, latency, and operational data for the CPU 114 and the GPU 116. For instance, the timeline reporter 106 receives data regarding how long the CPU threads 114-1 to 114-S took to complete their portion of the workload and the specific power consumption levels recorded during that time. In the example, the timeline reporter 106 inside the EMM 104 monitors one execution cycle of this workload. It determines that the CPU time (Tc) for the CPU 114 was 8 ms and the GPU time (Tg) for the GPU 116 was 12 ms. During this observation, it also measures that the two cores executed concurrently for an overlap period (To) of 3 ms. This concrete set of measurements (Tc=8 ms, Tg=12 ms, To=3 ms, Tt=16.67 ms) constitutes the historical average data that the timeline reporter 106 sends to the hybrid energy module 108.

The hybrid energy module 108 is the predictive engine. This module utilizes the historical data provided by the timeline reporter 106 to predict power consumption. The hybrid energy module 108 predicts the total time required and the total power consumed for the combined CPU 114 and GPU 116 operation under various candidate voltage and frequency combinations. The result of this calculation is the pool of execution-deadline-feasible combinations. Further in the example, the hybrid energy module 108 uses the historical data to predict that, if the CPU voltage and frequency were lowered by 10% and the GPU voltage and frequency were maintained, the next frame's predicted total time might increase to 18 ms, violating the 16.67 ms deadline. The EMM 104 would then search for a different, feasible combination.

The hybrid energy module 108 provides the total CPU power cost difference for different frequencies. Since modern CPU architectures usually have several cores within one cluster and they share the same clock frequency, changing the UI frame tasks'frequency can also affect other non-UI frame related tasks'execution power efficiency. When hybrid energy module 108 estimates the power consumption, it is necessary to consider all the CPU workloads running on the same cluster for the time period that the UI tasks are active. The extra power may be estimated based on: the total CPU cycles for all the tasks in the same cluster while the frame's tasks have been active, the total CPU cycles for all the tasks during the frame's target duration, and the latest CPU cluster power consumption. The system also uses predictive energy models to calculate the estimated power difference (ΔPower) required if the operating state changes. The predictive power cost for the first computing core (ΔPower_{cpu}) is calculated by considering the latest measured power (Powerₗₐₛₜ), the change in power efficiency (ΔPowerEfficiency_{cpu}) due to the new voltage/frequency combination, and the total instructions processed by the core cluster during the frame execution, as shown:

ΔPower_{cpu}=Powerₗₐₛₜ*ΔPowerEfficiency*ClusterInstructions_{frameActive}/ClusterInstructions_{targetDuration}

ΔPowerEfficiency_{cpu}=(PowerEfficiency_{lastOPP}−PowerEfficiency_{newOPP})/PowerEfficiency_{lastOPP}

In further aspects, the hybrid energy module 108 provides the power cost to run the frame related GPU workload. Similar to CPU, hybrid energy module 108 estimates the extra power consumption by the following formulas:

ΔPower_{gpu}=Powerₗₐₛₜ*ΔPowerEfficiency*GPUInstructions_{frameActive}/GPUInstructions_{targetDuration}

ΔPowerEfficiency_{gpu}=(PowerEfficiency_{lastOPP}−PowerEfficiency_{newOPP})/PowerEfficiency_{lastOPP}

With the estimated CPU and GPU energy models, the extra total power could be calculated for each combination of the new CPU device frequency and GPU device frequency. However, not every combination of frequencies are valid because they have to be quick enough to make the total frame duration (full time Tf) within the target duration (target time Tt). Based on the timeline information, the EMM 104 can predict the new CPU/GPU time under the new CPU/GPU frequency. The new frame total time can be calculated by the following formulas:

T_{newTotal}=T_{newCPU}*R_{cpuOnlyRate}+T_{newGPU}

R_{cpuOnlyRate}=T_{cpuOnlyAverage}/T_{cpuTotalAverage}

In aspects, the EMM 104 identifies all of the possible valid combinations of CPU and GPU device frequencies and chooses the one with the lowest total power consumption ΔPower=ΔPower_{cpu}+ΔPower_{gpu}.

The TMU 110 operates to ensure the system's compliance with safety limits. The TMU 110 receives temperature inputs and applies a constraint (such as a power budget or real-time frequency cap) that filters the pool of candidate voltage and frequency combinations calculated by the hybrid energy module 108. For instance, if the device temperature exceeds a predetermined level, the TMU 110 automatically restricts the EMM 104 from selecting any voltage and frequency combination that would draw too much power, regardless of its deadline feasibility.

The DVFS controller 112 acts as the actuator. After the EMM 104 selects the lowest-power, deadline-feasible, and thermally compliant voltage and frequency combination, the DVFS controller 112 adjusts the operating voltage and frequency of the CPU 114 and the GPU 116 accordingly. This action implements the coordinated power management decision by changing the operational speed and power draw of the processing cores.

The memory 120 is coupled to the EMM 104 and provides storage for the operating system, the code for the hybrid workload 202, and the historical data and lookup tables used by the timeline reporter 106 and the hybrid energy module 108.

In the example, the hybrid workload 202 drives the core processors, which, in turn, feed performance data back to the EMM 104. The EMM 104 uses this information to dynamically select the voltage and frequency combination that satisfies the shared deadline and thermal constraints while supporting the goal of achieving high power efficiency.

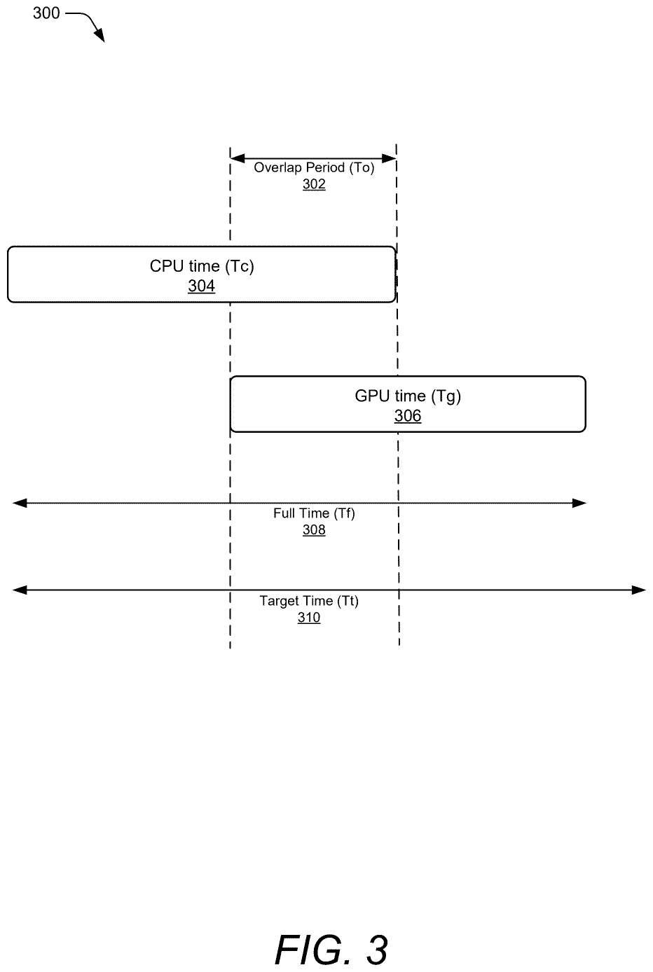

FIG. 3 illustrates an example processor core timeline, generally designated by reference numeral 300, showing the execution profile of a single past instance of a hybrid workload. This diagram provides the context for the timeline and execution data that the timeline reporter 106 acquires and that the hybrid energy module 108 uses for predictive modeling.

The primary time components of the hybrid workload are represented by the CPU time (Tc) 304 and the GPU time (Tg) 306. The CPU time (Tc) 304 represents the duration during which the first computing core (e.g., the CPU 114) actively executed its assigned portion of the hybrid workload. This workload often starts first, as the CPU typically handles initial setup, data preparation, and command submission tasks for the graphics portion of the workload.

The GPU time (Tg) 306 represents the duration during which the second computing core (e.g., the GPU 116) actively executed its assigned portion of the hybrid workload, such as rendering or computational tasks. The GPU's execution often begins after the CPU has prepared the initial command buffer.

The overlap period 302 (To) represents the time segment during which both the CPU 114 and the GPU 116 are actively executing threads simultaneously. This overlap period 302 occurs because the CPU 114 may continue performing post-submission or subsequent frame setup tasks even after it has initiated the workload on the GPU 116. The length of the overlap period 302 is implemented to calculating the total time required for the workload and for predicting how changing one core's operating speed will affect the total system duration.

The full time (Tf) 308 is the total duration, from the start of the CPU time 304 to the completion of the GPU time 306 (or the last task on either core). The full time 308 is derived by calculating the sum of the CPU time 304 and the GPU time 306, minus the overlap period 302. For example, referencing the frame rendering request example described in FIG. 2, if the CPU time 304 is 8 milliseconds and the GPU time 306 is 12 milliseconds, and the overlap period 302 is 3 milliseconds, the full time 308 is calculated as 8 ms+12 ms−3 ms=17 ms.

The target time (Tt) 310 represents the shared execution deadline for the hybrid workload. The target time 310 is the duration within which the full time 308 should be contained to meet the performance specification (e.g., referencing the example, the target time 310 is 16.67 milliseconds). The timeline reporter 106 acquires this target time 310, and the EMM 104 uses it as a constraint for identifying a plurality of execution deadline feasible voltage and frequency combinations. In the existing example, since the measured full time of 17 ms exceeds the target time of 16.67 ms, the EMM 104 determines that the operating voltage and frequency combination used in this historical instance is infeasible and should adjust to a faster combination for the next cycle.

### Example Methods

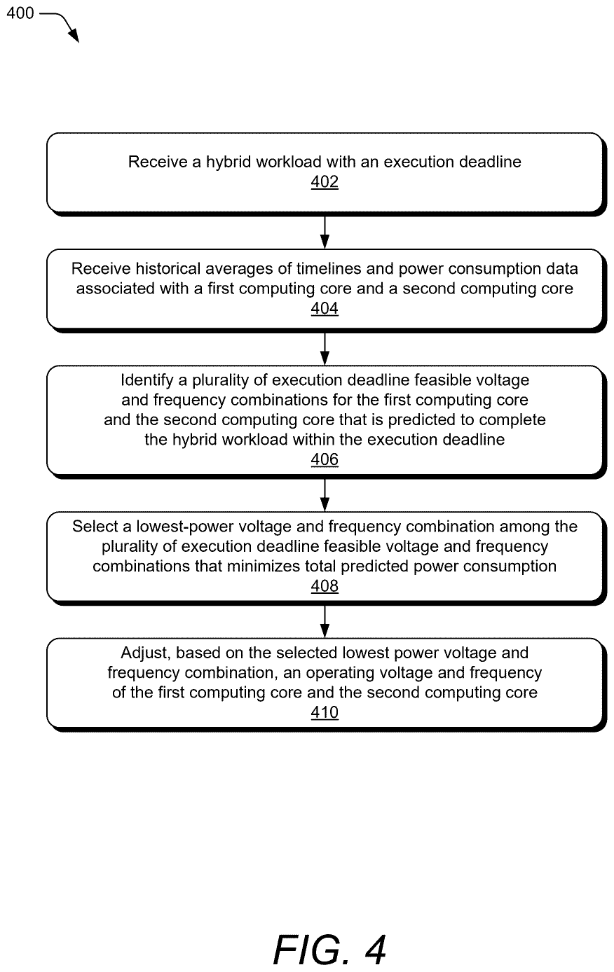

FIG. 4 illustrates an example method 400 for power and thermal management for multiple processing cores. In aspects, operations of the method 400 are implemented by or with computing device 102, EMM 104, timeline reporter 106, hybrid energy module 108, thermal management unit 110, DVFS controller 112, CPU 114, GPU 116, and memory 120.

Example method 400 is described with reference to FIGS. 1-3 in accordance with one or more aspects of power and thermal management for multiple processing cores. Generally, the method 400 illustrates sets of operations (or acts) performed in, but not necessarily limited to, the order or combinations in which the operations are shown herein. Further, any of one or more of the operations may be repeated, combined, reorganized, omitted, or linked to provide a variety of additional and/or alternate methods. In portions of the following discussion, reference may be made to the entities of FIGS. 1-3, reference to which is made for example only. The methods and apparatuses described in this disclosure are not limited to embodiment or performance by one entity or multiple entities operating in relation to power and thermal management for multiple processing cores.

At 402, the energy manager receives a hybrid workload with an execution deadline. The hybrid workload is a singular task (e.g. a frame rendering pipeline) that requires cooperation between the first computing core and the second computing core. The execution deadline represents the maximum time allowed for the workload to complete its processing and output the result. The energy manager accepts the hybrid workload and the associated deadline as the constraints governing the execution cycle.

At 404, the energy manager receives historical averages of timelines and power consumption data associated with the first computing core and the second computing core. The energy manager acquires this data from its internal timeline reporter 106. This historical information includes metrics such as the average time spent by each core on previous instances of the hybrid workload, the average recorded power draw at those times, and the period of overlap (To) between the two core's execution cycles (as detailed in FIG. 3). The energy manager requires this historical data to calibrate its internal predictive models.

At 406, the energy manager identifies a plurality of execution deadline feasible voltage and frequency combinations for the first computing core and the second computing core that is predicted to complete the hybrid workload within the execution deadline. The energy manager uses the historical averages received in the previous step (404) to calculate the predicted total execution time (T_{newTotal}) for every possible pairing of voltage and frequency settings (combinations) across both cores. Referencing the example from FIG. 3, the historical execution time of 17 milliseconds failed to meet the 16.67 millisecond deadline, meaning the previous operating combination is infeasible. The energy manager then uses its model to identify new candidate combinations. For instance, identifying one combination (combination X) may result in a predicted time of 18 milliseconds (infeasible), while another combination (combination Y) may result in a predicted time of 16.0 milliseconds (feasible). The energy manager filters the complete set, retaining only combinations predicted to result in a total execution time less than or equal to the execution deadline. This subset forms the “plurality of execution deadline feasible voltage and frequency combinations.”

At 408, the energy manager selects a lowest-power voltage and frequency combination among the plurality of execution deadline feasible voltage and frequency combinations that minimizes total predicted power consumption. For every combination remaining in the plurality from the previous step (406), the energy manager uses its internal hybrid energy module 108 to calculate the combined or “total predicted power consumption” (ΔPower_{cpu}+ΔPower_{gpu}). The energy manager performs this selection step to identify the combination that consumes the least total power while still meeting the required performance deadline. For example, the energy manager may find two feasible combinations: combination A: predicted time of 16.0 ms (feasible), predicted power cost of 1200 mW; and combination B: predicted time of 15.0 ms (feasible), predicted power cost of 1350 mW. The energy manager performs this selection step to identify combination A, as it consumes the least total power (1200 mW) while still meeting the required performance deadline.

At 410, the energy manager adjusts, based on the selected lowest power voltage and frequency combination, an operating voltage and frequency of the first computing core and the second computing core. The energy manager outputs the settings corresponding to the selected combination (e.g., combination A from step 408) to its internal DVFS controller 112. The DVFS controller 112 then implements these control signals, changing the voltage and frequency at which the first computing core (CPU 114) and the second computing core (GPU 116) operate for the next execution cycle of the hybrid workload.

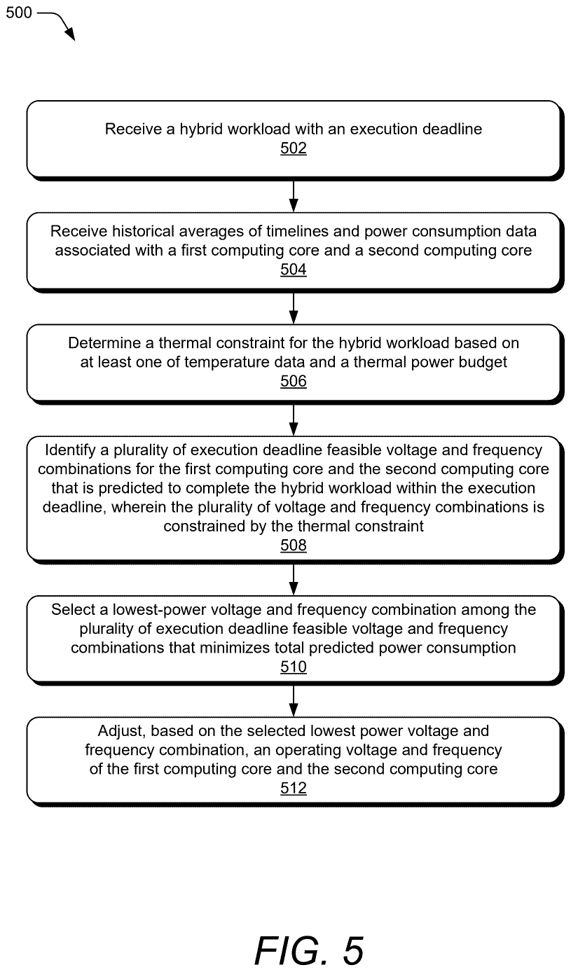

FIG. 5 illustrates an example method 500 for power and thermal management for multiple processing cores. In aspects, operations of the method 500 are implemented by or with computing device 102, EMM 104, timeline reporter 106, hybrid energy module 108, thermal management unit 110, DVFS controller 112, CPU 114, GPU 116, and memory 120.

Example method 500 is described with reference to FIGS. 1-4 in accordance with one or more aspects of power and thermal management for multiple processing cores. Generally, the method 500 illustrates sets of operations (or acts) performed in, but not necessarily limited to, the order or combinations in which the operations are shown herein. Further, any of one or more of the operations may be repeated, combined, reorganized, omitted, or linked to provide a variety of additional and/or alternate methods. In portions of the following discussion, reference may be made to the entities of FIGS. 1-4, reference to which is made for example only. The methods and apparatuses described in this disclosure are not limited to embodiment or performance by one entity or multiple entities operating in relation to power and thermal management for multiple processing cores.

Thermal throttling, a technique used to manage the temperature of CPUs and GPUs, may lead to suboptimal performance. In aspects, over-throttling can cause processing delays and jeopardize frame processing timelines, while under-throttling can waste power by unnecessarily speeding up processing. To address this issue, the EMM 104 implements a feedback mechanism that monitors CPU/GPU frame processing duration and compares it to the target timeline. This will allow for real-time adjustments to the thermal throttling settings. By leveraging the available “headroom” (the difference between the actual processing time and the target timeline) the system can dynamically improve power consumption without sacrificing performance. In aspects, this approach aims to fine-tune the thermal throttling process by continuously evaluating the system's workload and adjusting the throttling level accordingly. This will ensure that the system operates within safe thermal limits while improving power efficiency and maintaining the desired level of performance. Thermal headroom can be defined as the availability of additional throttling opportunities without impacting performance.

Thermal Headroom=Target Duration−Total Frame Processing Time

Total Processing Time=CPU Time+GPU Time—Overlap

If thermal headroom is positive, that indicates that there are opportunities for additional CPU/GPU throttling. Whereas a negative headroom indicates a need to release throttle to reduce performance impact.

At 502, the energy manager receives a hybrid workload with an execution deadline. Similar to the process shown in FIG. 4, the energy manager accepts the single, cooperative task and the time limit imposed for its successful completion.

At 504, the energy manager receives historical averages of timelines and power consumption data associated with a first computing core and a second computing core. This data includes past performance profiles, average power draw, and measurements of the overlap period during simultaneous execution. The energy manager uses this historical input to establish its predictive models for the next cycle.

At 506, the energy manager determines a thermal constraint for the hybrid workload based on at least one of temperature data and a thermal power budget. The energy manager accesses information from its internal thermal management unit (TMU 110), which monitors the current temperature sensors of the CPU 114 and the GPU 116. Based on this data, the energy manager imposes a limit, known as the thermal constraint, on the overall power draw permitted for the first computing core and the second computing core. This constraint may be a simple fixed thermal power budget or a dynamic limit that shifts based on the device's immediate thermal state.

At 508, the energy manager identifies a plurality of execution deadline feasible voltage and frequency combinations for the first computing core and the second computing core that is predicted to complete the hybrid workload within the execution deadline, where the plurality of voltage and frequency combinations is constrained by the thermal constraint. The energy manager performs a predictive modeling search, as described in relation to FIG. 4, to find combinations that meet the required execution deadline. However, before finalizing the plurality, the energy manager filters out any combination that would cause the total power consumption to exceed the thermal constraint determined in step 506. This process ensures that the resulting set of feasible options is also thermally permissible, creating a real-time cap on the operational space of the cores.

At 510, the energy manager selects a lowest-power voltage and frequency combination among the plurality of execution deadline feasible voltage and frequency combinations that minimizes total predicted power consumption. From the set of thermally constrained and deadline-feasible combinations resulting from step 508, the energy manager calculates the total predicted power consumption for each remaining option. The energy manager then performs the selection to identify the single combination that consumes the least total power from the available options. This is the most power-efficient operating point that simultaneously respects both the performance deadline and the current thermal capacity of the device.

At 512, the energy manager adjusts, based on the selected lowest power voltage and frequency combination, an operating voltage and frequency of the first computing core and the second computing core. The energy manager directs the DVFS controller 112 to implement the selected voltage and frequency settings on the first computing core and the second computing core. This adjustment completes the method by changing the operating state of the cores for the subsequent execution cycle of the hybrid workload.

### Conclusion

Although aspects of power and thermal management for multiple processing cores has been described in language specific to features and/or methods, the subject of the appended claims is, as recited by any of the previous examples, not necessarily limited to the specific features or methods described. Rather, the specific features and methods are disclosed as example implementations of power and thermal management for multiple processing cores, and other equivalent features and methods are intended to be within the scope of the appended claims. Further, various aspects of power and thermal management for multiple processing cores are described, and it is to be appreciated that each described aspect may be implemented independently or in connection with one or more other described aspects.

What is claimed is:

1. A method comprising:
receiving a hybrid workload with an execution deadline;
identifying, based on timeline data and power consumption data, a plurality of voltage and frequency combinations for a first computing core and a second computing core by which to complete the hybrid workload within the execution deadline; and
adjusting, based on a selected one of the voltage and frequency combinations, an operating voltage and frequency of the first computing core and the second computing core, the adjustment effective to cause the first computing core and the second computing core to complete the hybrid workload within the execution deadline.

2. The method of claim 1, wherein the first computing core is a central processing unit (CPU) and the second computing core is a graphics processing unit (GPU).

3. The method of claim 2, wherein the timeline data and power consumption data further includes data associated with a third computing core, the third computing core comprising a tensor processing unit (TPU) or a neural processing unit (NPU).

4. The method of claim 1, wherein the identifying includes determining a predicted total completion time using the first computing core and the second computing core and comparing the predicted total completion time to the execution deadline.

5. The method of claim 2, wherein the identifying includes estimating a power cost difference for the CPU that is calculated based on:
a latest measured power of a core cluster associated with the CPU;
a change in a power efficiency due to the adjusting the operating voltage and frequency to the selected one of voltage and frequency combinations; and
a ratio of total processing cycles for active hybrid workload tasks relative to total processing cycles for a target duration of the core cluster.

6. The method of claim 5, wherein the power efficiency is estimated based on:
a previous operating efficiency of the CPU; and
a new operating efficiency of the CPU.

7. The method of claim 6, wherein the identifying further includes estimating a total power consumption by summing the estimated power cost difference for the CPU and an estimated power cost difference for the GPU.

8. The method of claim 1, wherein the adjusted operating voltage and frequency results in the first computing core and the second computing core collectively consuming a lower power than at least one of the plurality of voltage and frequency combinations.

9. An apparatus comprising:
a first computing core;
a second computing core;
a memory configured to store a hybrid workload and historical timeline data; and
an energy management module configured to:
receive a hybrid workload with an execution deadline;
identify, based on timeline data and power consumption data, a plurality of voltage and frequency combinations for a first computing core and a second computing core by which to complete the hybrid workload within the execution deadline; and
adjust, based on a selected one of the voltage and frequency combinations, an operating voltage and frequency of the first computing core and the second computing core.

10. The apparatus of claim 9, wherein the first computing core is a central processing unit (CPU) and the second computing core is a graphics processing unit (GPU).

11. The apparatus of claim 10, wherein the energy management module includes an internal hybrid energy model configured to calculate a total predicted power consumption.

12. The apparatus of claim 10, further comprising a thermal management unit (TMU) coupled to the energy management module, the TMU configured to provide temperature data to the energy management module.

13. The apparatus of claim 9, wherein the energy management module is further configured to predict the completion time for the hybrid workload by determining the first computing core's execution time, the second computing core's execution time, and an overlap period between the first computing core's execution time and the second computing core's execution time.

14. The apparatus of claim 9, further comprising a third computing core, the third computing core comprising a tensor processing unit (TPU) or a neural processing unit (NPU).

15. The apparatus of claim 9, wherein the energy management module is configured to perform the adjustment by signaling a dynamic voltage and frequency scaling (DVFS) controller to adjust the operating voltage and frequency of the first computing core and the second computing core.

16. A method comprising:
receiving a hybrid workload with an execution deadline;
determining a thermal constraint for the hybrid workload based on at least one of temperature data and a thermal power budget;
identifying, based on timeline data and power consumption data, a plurality of voltage and frequency combinations for a first computing core and a second computing core by which to complete the hybrid workload within the execution deadline, where the plurality of voltage and frequency combinations is constrained by the thermal constraint; and
adjusting, based on a selected one of the voltage and frequency combinations, an operating voltage and frequency of the first computing core and the second computing core.

17. The method of claim 16, wherein the determining a thermal constraint includes calculating a thermal headroom, wherein the thermal headroom is the difference between the execution deadline and a total frame processing time of the hybrid workload.

18. The method of claim 17, wherein the total frame processing time is calculated as the sum of the time spent by the first computing core and the second computing core minus an overlap period of the processing.

19. The method of claim 17, wherein the thermal constraint applies a frequency cap that limits the available execution deadline feasible voltage and frequency combinations.

20. The method of claim 17, wherein the thermal constraint is adjusted based on the thermal headroom being positive or negative, wherein when the headroom is positive, the constraint applies throttling, and when the headroom is negative, the constraint releases throttling.
